(19) United States
(12) Patent Application Publication
(10) Pub. No.: US 2006/0057343 A1
(43) Pub. Date: Mar. 16, 2006

(54) Light-scattering composite agricultural film

(76) Inventors: Hideoki Tsuji, Osaka (JP); Masayoshi Ichinomiya, Matsuyama-shi (JP); Masanori Ichinomiya, Matsuyama-shi (JP); Kenichi Morita, Matsuyama-shi (JP)

Correspondence Address: JOHN S. PRATT, ESQ;KILPATRICK STOCKTON, LLP, 1100 PEACHTREE STREET, ATLANTA, GA, 30309, US

(21) Appl. No.: 11/218,058

(22) Filed: Aug. 31, 2005

(30) Foreign Application Priority Data
Sep. 1, 2004 (JP) P2004-254560

(51) Int. Cl. B32B 7/02

(52) U.S. Cl. 428/212

(57) ABSTRACT

A transparent base film and a transparent resin layer are provided. An ultraviolet absorbent is contained in at least either of the base film and the resin layer, and a transmittance of an ultraviolet ray with a wavelength of 380 nm is set at 60% or less. On a surface of the resin layer, numerous irregularities are provided, in which an total luminous transmittance is 85% or more, and a diffuse transmittance is 6% or more.

### BACKGROUND OF THE INVENTION

1. Field of the Invention

The present invention relates to a light-scattering composite agricultural film effective for cultivation of crops, and particularly, to a light-scattering composite agricultural film formed by compounding, on a transparent base film, a transparent resin layer having numerous irregularities on a surface thereof.

2. Description of the Related Art

Heretofore, polyethylene film, polyvinyl chloride film, polyester film have been used as coating material of agricultural tunnels and pipe house. Moreover, an ultraviolet resistant film formed by mixing an ultraviolet absorbent with such a film and a film enhancing a moisture retention thereof have also been commercially available. In recent years, it has been known that scattered light uniformly reaches the entire plant enhancing the photosynthesis rate thereof in the case of using a light-scattering film as the film as described above, and that the use of the light-scattering film is therefore effective for cultivation of plants.

In Japanese Patent Laid-Open Publication No. H07-102046 (published in 1995), there is disclosed an agricultural polyvinyl chloride film that is anisotropic and light-scattering, in which a large number of irregular streaks are arrayed parallel to one another at least on one surface thereof, and fine planes exist between the adjacent streaks, wherein 30% to 80% of the entire surface area of the irregular streaks includes slanted surfaces each having an inclination of 5° to 40° with respect to the surface of the film, and 70% to 20% of the entire surface area includes so-called horizontal planes each having an inclination of 0° to 5° with respect to the surface of the film. However, this film has regularity in the irregular streaks, and light is scattered only in a width direction of the irregular streaks. Accordingly, many shaded leaf portions, which are not exposed to the light remain. Moreover, since the irregular streaks are processed directly on a base film, the strength of the base film is lowered.

In Japanese Patent Laid-Open Publication No. 2002-139607, there is disclosed a method of obtaining a light-scattering functional film by coating foaming resin thereon though agricultural film is not a subject of the method. However, it is difficult to uniformly control bubbles formed by foaming the foaming resin in a dispersive manner. Moreover, when a layer of the resin is thin, the bubbles are broken and disappear.

In Japanese Patent Laid-Open Publication No. H11-337711 (published in 1999), there is disclosed a highly light-scattering film obtained by adding thereto a light diffuser formed of spherical particles with a particle diameter of 1 to 20 μm in a predetermined weight ratio, and by coating thereon a highly light-diffusive paint adjusted to a predetermined viscosity by a volatile solvent, followed by drying of the coated paint. However, it is difficult to coat the paint containing the spherical particles with the particle diameter of 1 to 20 μm while uniformly distributing the particles thereof. Moreover, light incident onto the highly light-scattering film reflects diffusely, and an total luminous transmittance thereof is lowered. In addition, the light diffuser is expensive at present.

### SUMMARY OF THE INVENTION

The present invention has been created in order to solve the above-described problems. It is an object of the present invention to provide a light-scattering composite agricultural film, which has a high total luminous transmittance, a good light-scattering property for transmission light, and a low ultraviolet transmittance, and is effective for controlling the cultivation and growth of plants.

To achieve the above object, an aspect of the present invention is a light-scattering composite agricultural film including: a transparent base film; and a transparent resin layer, wherein at least either of the base film and the resin layer contains an ultraviolet absorbent, and has a transmittance of an ultraviolet ray with a wavelength of 380 nm of 60% or less, and the resin layer includes, on a surface thereof, numerous irregularities, in which an total luminous transmittance is 85% or more, and a diffuse transmittance is 6% or more.

According to the feature of the present invention, in the light-scattering composite agricultural film, the ultraviolet absorbent is contained, and the transmittance of the ultraviolet ray with a wavelength of 380 nm is 60% or less. Accordingly, a major part of the ultraviolet ray that is harmful to the crops is cut, the growth of the crops in the agricultural house is prompted, and invasion of various insect pests is restricted. Meanwhile, on the surface of the transparent resin layer B, the numerous irregularities in which the total luminous transmittance is 85% or more and the diffuse transmittance is 6% or more are provided. Accordingly, an amount of light in the agricultural house bears comparison with that of the outside of the house, and the photosynthesis of the plant is actively performed. Moreover, there are effects that the scattered light reaches also the shaded leaf portions which are not exposed to direct light, the entire plant enhances the photosynthesis efficiency thereof, color unevenness of fruits and flesh vegetables is restricted, and commercial values thereof are enhanced.

A haze value (=diffuse transmittance/total luminous transmittance×100%) of the light-scattering composite agricultural film may be 50% or less.

With the above-described configuration, the inside of the agricultural house is visible from the outside thereof, and agricultural workability is enhanced.

The numerous irregularities may form a random and irregular sine curve on an arbitrary vertical cross section.

With the above-described configuration, the scattered light generated by the irregularities does not have regularity, the entire transmission light repeats crossing continuously, and light beam intensities are equalized from a macroscopic view. Specifically, such an effect as “smoothing hot water (stirring hot spring water by using paddle-like wooden boards to cool the water down)” for the light appears, and the light becomes gentle and soft beams and scatters evenly in the house. Then, the light falls on leaves of the plant. Accordingly, sunburn of the leaves as in the case of only the direct light is restricted, and the light also reaches evenly the shaded leaf portions, which are not directly exposed to the direct light. Then, the entire plant performs the photosynthesis uniformly, which favorably affects the growth of the plant. Furthermore, when the total luminous transmittance becomes 85% or more, a haze value becomes 50% or less, and a diffuse transmittance by irregular scattering generated by the numerous irregularities becomes 10% or more, the sunbeam viewed from the inside of the house irregularly shines brilliantly, and comes to glimmer owing to vibrations of the film and a slight movement of human eyes (hereinafter, the above is referred to as a “brilliant shining/flickering phenomenon”). This brilliant shining/flickering phenomenon restricts the invasion of the various insect pests into the inside of the house and breeding thereof.

The base film may be: (a) a film made of any of polyvinyl chloride, polyvinylidene chloride, polyethylene, polypropylene, ethylene-vinyl acetate resin, ethylene-vinyl alcohol resin, polyester, polyamide, polyvinyl fluoride, polyvinyl alcohol, and biodegradable resin of polylactic acid, or (b) a composite laminate film of these, or (c) a film of these in which hydrophilicity is imparted to at least one surface thereof by a treatment including a corona discharge treatment, a plasma discharge treatment, an ultraviolet treatment, an ozone treatment, and a treatment using catalysts including titanium-oxide photocatalysts and a titanium-phosphate air catalyst.

With the above-described configuration, the base film is excellent in transparency, strength, weatherability, and adhesiveness onto the resin layer, and also has an effect of preventing pollution of the surface of the film.

The resin layer may be made of at least one resin selected from acrylic ester polymers, styrene polymers, styrene-acrylic ester polymers, a vinyl acetate polymer, a copolymer formed of vinyl acetate and a monomer represented by the following formula, an ethylene-vinyl acetate copolymer, an ethylene-vinyl acetate-vinyl chloride copolymer, vinyl chloride polymers, a vinylidene chloride polymer, an acrylic-silicon copolymer, silica-containing acrylic resin, urethane resin, urethane-modulated acrylic resin, polyester resin, polybutadiene, polyethylene, an ethylene-methacrylic acid copolymer, epoxy resin, silicon resin, fluorine resin, biodegradable resin of polylactic acids, SBR(styrene-butadiene copolymer rubber), NBR(acrylonitrile-butadiene copolymer rubber), and MBR(methylmethacrylate-butadiene copolymer rubber):

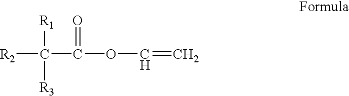

wherein R₁, R₂, and R₃ are alkyl groups.

With the above-described configuration, it is possible to take appropriate measures in response to target performance such as the transparency, the weatherability, waterproofness, adhesiveness onto a coated material (base film), and a fog resistance.

The resin layer may be formed by coating and drying a water-soluble or water-dispersive resin paint containing the ultraviolet absorbent.

With the above-described configuration, in comparison with the case of pasting together the base film and the resin layer containing the ultraviolet absorbent, making irregularities on the resin layer, and creating the light-scattering composite agricultural film in a film-forming process, there are advantages that bubbles and wrinkles which occur in the case of pasting the two films together do not occur and cost is also inexpensive. Moreover, in comparison with a resin coating layer formed by coating and drying solvent paints, there are no problems which are concerned with environmental pollution, VOC regulation, and hazardous substance handling, and are intrinsic to the solvent paints, such as difficulty cleaning a coater by using water.

A primer layer made of adhesiveness-improving resin may be provided on a surface of the base film on the resin layer side, when the base film is an adherence-resistant film made of a material including polyolefin resin, polyester resin, and fluorine resin.

With the above-described configuration, there is an effect that the adhesiveness between the base film and the resin layer is enhanced.

### BRIEF DESCRIPTION OF THE DRAWINGS

FIG. 1 is a schematic plan view of a light-scattering composite agricultural film obtained by a sponge roller coating method according to an embodiment of the present invention.

FIG. 2 is a cross-sectional view taken by arrows II-II of FIG. 1.

FIG. 3 is an enlarged view of a portion III of FIG. 2.

FIG. 4 is a schematic plan view of another light-scattering composite agricultural film obtained by a spray coating method according to the embodiment of the present invention.

FIG. 5 is a cross-sectional view taken by arrows V-V of FIG. 4.

FIG. 6 is an enlarged view of a portion VI of FIG. 5.

FIG. 7 is a perspective view showing an example of a sponge roller coater according to the embodiment of the present invention.

FIG. 8 is a perspective view showing an example of a spray coater according to the embodiment of the present invention.

### DETAILED DESCRIPTION OF THE PREFERRED EMBODIMENT

An embodiment of the present invention is described below based on the drawings. In the following description based on the drawings, the same or similar reference numerals are assigned to the same or similar portions. However, the drawings are schematic, and it should be noted that a relationship between each thickness and each plane dimension, a ratio of the thickness of the respective layers, and the like are different from actual ones. Hence, specific thicknesses and dimensions should be determined in consideration of the following description. Moreover, it is a matter of course that portions where the mutual dimensional relationships and ratios differ from each other are also included in the drawings.

Moreover, the embodiment shown below illustrates apparatuses and methods for embodying the technical idea of this invention. The technical idea of this invention can be altered variously within the scope of claims.

The present invention is a light-scattering composite agricultural film formed of a transparent base film A and a transparent resin layer B, characterized in that an ultraviolet absorbent is contained in at least either one of the base film A and the resin layer B, a transmittance of an ultraviolet ray with a wavelength of 380 nm is 60% or less, and on a surface of the resin layer B, numerous irregularities are provided, in which an total luminous transmittance is 85% or more, and a diffuse transmittance is 6% or more.

As the base film A, there is used a film made of polyvinyl chloride, polyvinylidene chloride, polyethylene, polypropylene, ethylene-vinyl acetate resin, ethylene-vinyl alcohol resin, polyester, polyamide, polyvinyl fluoride, polyvinyl alcohol, or biodegradable resin of polylactic acid or the like, or a composite laminate film of these. These films are selectable according to the purpose corresponding to properties such as transparency, strength, weatherability, and cost, or the like; however, usually a polyvinyl chloride film or a polyethylene film is frequently used.

It is preferable to impart hydrophilicity to one surface or both surfaces of the base film A by a corona discharge treatment, a plasma discharge treatment, an ultraviolet treatment, an ozone treatment, and a treatment using titanium-oxide photocatalysts or a titanium-phosphate air catalyst, and the like. In such a way, adhesiveness of the base film A onto the resin layer B is enhanced. In this case, a primer layer is unnecessary in general.

Although it is easy to perform a treatment to impart the hydrophilicity in a factory line, it is difficult to perform such a hydrophilicity-imparting treatment for the base film A previously placed on the existing agricultural house. Accordingly, instead of performing the hydrphilicity-imparting treatment, a primer layer C for improving the adhesiveness may be provided by coating and drying the same in between the base film A and the resin layer B, and in such a way, the adhesiveness between the base film A and the resin layer B is enhanced. Specifically, a material of the primer layer C includes acrylic copolymer resin emulsion, rubber latex of natural rubber, NBR, SBR, or the like, emulsions of styrene block copolymers such as a styrene-isoprene-styrene block copolymer, a styrene-butadiene-styrene block copolymer, and a styrene-ethylene-butylene-styrene block copolymer, emulsion of chlorinated polypropylene, urethane resin emulsion, ethylene-vinyl acetate copolymer emulsion, ethylene-vinyl acetate-vinyl chloride copolymer emulsion, ethylene-methacrylic acid copolymer emulsion, and one obtained by compounding, to these emulsions, tackifier such as rosin ester resin and tenpene resin emulsions, oil, a softening agent such as polybutene, a wettability improver such as alcohol and an emulsifier, and the like. However, in the case of coating the primer layer C on the film of the existing agricultural house at normal temperature, followed by drying, aqueous emulsion of viscous acrylic resin with a glass transition point of −10° C. or less is usually suitable. It is needless to say that it is also easy to coat these substances in the factory line.

For the resin layer B, at least one resin may be used, which includes acrylic ester polymers, styrene polymers, styrene-acrylic ester polymers, a vinyl acetate polymer, and a copolymer formed of vinyl acetate and a monomer represented by the following formula: 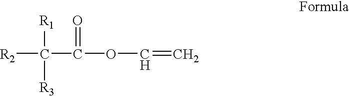
wherein R₁, R₂, and R₃ are alkyl groups. The monomer represented by this formula includes, for example, Veova 9, Veova 10, and the like, in which Veova 9 is represented as: R₁+R₂+R₃═C₇H₁₅; and Veova 10 is represented as: R₁+R₂+R₃═C₈H₁₇. Moreover, examples of the resin that may be used for the resin layer B include an ethylene-vinyl acetate copolymer, an ethylene-vinyl acetate-vinyl chloride copolymer, vinyl chloride polymers, a vinylidene chloride polymer, an acrylic-silicon copolymer, silica-containing acrylic resin, urethane resin, urethane-modulated acrylic resin, polyester resin, polybutadiene, polyethylene, an ethylene-methacrylic acid copolymer, epoxy resin, silicon resin, fluorine resin, biodegradable resin of polylactic acid or the like, SBR, NBR, MBR, and the like. Suitable resin is selectable in response to target performance such as the transparency, the weatherability, the waterproofness, the adhesiveness onto the base film A, the fog resistance, and the cost. In usual, a resin layer formed by coating and drying a paint using polymer emulsion of acrylic acid ester or the like as a base is suitable.

Moreover, for the base film A, polyvinyl chloride is inexpensive and durable and has good handleability, and accordingly, has been heretofore used most often as agricultural film. On the other hand, a plasticizer contained in the polyvinyl chloride is transferred to the resin layer B, causing a surface of the resin layer B to be sticky. In this way, the surface of the resin layer B is sometimes polluted, and the house film sometimes causes blocking in the case of being wound up. In order to prevent the above, it is preferable to coat and dry resin formed by copolymerizing an acrylonitrile monomer, for example, transparent resin mainly containing aqueous emulsion with Tg or MFT at about 20 to 60° C., which is styrene-acrylonitrile-acrylic acid ester copolymer resin, thereby forming the resin layer B.

The ultraviolet absorbent is contained in the light-scattering composite agricultural film of the present invention, in which the transmittance of the ultraviolet ray with the wavelength of 380 nm is 60% or less. The ultraviolet absorbent includes benzophenones, benzotriazoles, benzoates, cyanoacylates, fine zinc oxide, fine titanium oxide, fine cerium oxide, fine zirconium oxide, fine iron oxide, and the like.

There are three kinds in the ultraviolet ray, which are: the UV-A (320 to 400 nm); the UV-B (280 to 320 nm); and the UV-C (190 to 280 nm). The UV-C, which is most harmful, is absorbed by the ozone layer in the atmosphere, and does not reach the earth. Accordingly, the subject to be treated is the UV-A and the UV-B. The adverse effect of the ultraviolet ray on the crops is well known, and the ultraviolet rays of the UV-A and the UV-B, and in particular, the ultraviolet ray with a wavelength of 350 to 380 nm restrains the growth of the plants in general. Generally speaking, the shorter the wavelength of the ultraviolet ray is, the more radically the transmittance of the ultraviolet ray tends to be reduced. Accordingly, if the transmittance of the ultraviolet ray with the wavelength of 380 nm is 60% or less, a major part of the ultraviolet ray with the wavelength of 350 to 380 nm is also cut off. As described above, in the light-scattering composite agricultural film of the present invention, the transmittance of the ultraviolet ray with the wavelength of 380 nm is 60% or less, and accordingly, growth of many vegetables is prompted. Moreover, there is also an effect of preventing an occurrence and invasion of insect pests in the inside of the house.

Besides the ultraviolet absorbent, an infrared absorbent or shielding agent may be contained in the light-scattering composite agricultural film of the present invention. A specific infrared absorbent includes NIR-AM 1 to 4 (aluminum salt made by Nagase ChemteX Corporation), NIR-IM 1 to 4 (iminium salt made by Nagase ChemteX Corporation), SDA-8470 (nickel complexmadebyTosco Co., Ltd.), SDA-8662, -1037, -8051, -4972, -8700, -6122, -8080 (made by Tosco Co., Ltd.), SIR-128,-130, -159 (metal complex made by Mitsui Chemicals, Inc.), PA-1001, -1005 (metal complex made by Mitsui Chemicals, Inc.), EPOLITE 1125, 1178, 2057, 4129, 1117, 2063, 3063 (made by Epolin, Inc.), ATO (antimony-doped tin oxide made by Sumitomo Osaka Cement Co., Ltd.), ITO (tin-doped indium oxide made by Sumitomo Osaka Cement Co., Ltd.), Snowtex C (colloidal silica made by Nissan Chemical Industries, Ltd.), and the like.

The infrared ray includes the near infrared ray (wavelength: 0.75 to 20 μm), and the far infrared ray (wavelength: 20 to 1000 μm). Although direct effects of the infrared ray on crops remains uncertain, when the infrared ray is cut by the agricultural film, a temperature rise in the agricultural house in summer and daytime is restricted, and a temperature drop at nighttime is restricted. Accordingly, a temperature difference in between daytime and nighttime is reduced, which favorably affects the growth of the plant in the agricultural house.

Although the ultraviolet absorbent and the infrared absorbent or shielding agent may be contained in both of the base film A and the resin layer B, this is not preferable because a cost increase is caused. Moreover, in the case of containing the ultraviolet absorbent and the infrared absorbent or shielding agent only in the base film A, it is not preferable to dispose the resin layer B toward the outside of the agricultural house because the resin layer B tends to be deteriorated by the ultraviolet ray. On the contrary, when the base film A is made of polyvinyl chloride, it is not preferable to dispose the resin layer B toward the inside of the agricultural house because the plasticizer is bled out to the outside, causing sticky pollution. Hence, it can be said that it is the most preferable to contain the ultraviolet absorbent and the infrared absorbent or shielding agent in the resin layer B, and to place the light-scattering composite agricultural film on the agricultural house while disposing the resin layer B toward the outside. In such a way, the base film is protected from ultraviolet rays and pollution, and deterioration of the resin layer B is also restricted because the resin layer B contains the ultraviolet absorbent.

On the surface of the resin layer B, the numerous irregularities are provided, in which the total luminous transmittance of the light-scattering composite agricultural film is 85% or more, preferably 88% or more, and more preferably 90% or more, and the diffuse transmittance is 6% or more, preferably 10% or more, and more preferably 20% or more. When the total luminous transmittance drops to less than the above-described lower limit, the total amount of light in the agricultural house is reduced, and following this reduction, the photosynthesis of vegetables is also lowered. Moreover, in winter, the temperature retention in the agricultural house becomes insufficient, and accordingly, such lowering of the total luminous transmittance is not good. Moreover, when the diffuse transmittance drops to less than the above-described lower limit, portions of the crops in the agricultural house, which are not directly exposed to the light, are increased, unevenness in the photosynthesis occurs, and unevenness in color occurs in fruits and vegetables, leading to lowering of their commercial values. Accordingly, such lowering of the diffuse transmittance is not good. However, when the diffuse transmittance is too high, that is, when the haze value (=diffuse transmittance/total luminous transmittance×100%) is increased to exceed 50%, an opaque feeling is increased, and it becomes difficult to see persons and the plant in the agricultural house from the outside thereof. This is not preferable in terms of agricultural workability, and in addition, a brilliant shining/flickering phenomenon does not come to occur. Note that the transparent resin layer B mentioned in the present invention refers to that resin to be used for the resin layer B is transparent, and even if the transparency of the resin layer B is lowered owing to the numerous irregularities on the surface thereof, there occurs no problem on the cultivation and growth of the plant as long as the total luminous transmittance is equal to or more than the above-described value.

In the present invention, the total luminous transmittance and the diffuse transmittance are ones measured according to JIS K-7105 by using a double beam-type haze computer HGM-2B made by Suga Test Instruments Co., Ltd.

The numerous irregularities may form a random and irregular sine curve on an arbitrary vertical cross section. When the numerous irregularities have regularity, the scattered light generated by the numerous irregularities becomes monotonous, cause unevenness, and does not come to be scattered evenly. This is not preferable also in terms of the cultivation and growth of the plant and in terms of pest control of the insects.

When the above-described numerous irregularities exist, the total luminous transmittance becomes 85% or more, the diffuse transmittance becomes 10% or more, and the haze value becomes 50% or less, the brilliant shining/flickering phenomenon of the light occurs. The above-described diffuse transmittance and brilliant shining/flickering phenomenon of the light become large factors in restricting the invasion of the insect pests such as silverleaf whiteflies into the inside of the house and breeding thereof in comparison with an ultraviolet absorbing film having an equivalent ultraviolet resistant rate.

The agricultural film, and particularly, that of the polyvinyl chloride is prone to be contaminated. Accordingly, at least on an outer side surface of the light-scattering composite agricultural film of the present invention, there may be provided a contamination resistant layer formed by spraying and drying water or an alcohol dispersion liquid with a carbon number of 1 to 3, which contains at least one of inorganic substances consisting of the group of titanium oxide photocatalysts, titania phosphate catalysts, titanium tetrachloride, phosphoric acid or derivatives thereof, and silicate. Here, for the purpose of enhancing the adhesiveness onto the composite film, it is recommended to mix, as binder resin, an appropriate amount of acrylic emulsion, silicon resin emulsion, acrylic-silicon copolymer emulsion, fluorine resin emulsion, or silica-containing acrylic emulsion with the water or the alcohol dispersion liquid. By providing the contamination resistant layer as described above, the contamination of the surface of the composite film is prevented, and an effect of maintaining a large amount of transmittance of visible light into the house for a long period is thus imparted.

With regard to the transparent resin layer B having the numerous irregularities on the surface of the light-scattering composite agricultural film, the resin layer containing the ultraviolet absorbent and the base film are pasted together in a film-forming process, the irregularities are processed on the resin layer B, and in such a way, the light-scattering composite agricultural film may be prepared. However, in this case, bubbles and wrinkles occur when the two films are pasted together, and the cost is increased. Accordingly, it can be said that it is preferable to coat, on the base film, a transparent resin paint containing the ultraviolet absorbent so as to generate the numerous irregularities in terms of the quality and the cost.

Heretofore, organic solvent resin paints have been used as the resin paint to be coated on the base film. As opposed to this, under the present circumstances, aqueous resin paints are hardly employed in film manufacturers because evaporative latent heat of water is large. However, if a coating amount of such an aqueous paint is within a range of 5 to 50 g/m², drying conditions thereof bear comparison with those of the solvent paint beyond expectation. On the contrary, such a solvent paint has intrinsic problems, for example, which are concerned not only with environmental pollution, VOC regulation, and hazardous substance handling but also with difficulty cleaning a coater by using water. In this connection, it can be said that the aqueous resin paints are superior.

As a method of coating the aqueous resin paint on the surface of the base film A so as to generate the numerous irregularities, the following five coating methods are mentioned.

(1) Sponge roller coating method: method of naturally imparting the irregularities to the coating surface by coating the paint by using a sponge roller having a large number of dimple holes on a surface thereof.

(2) Spray coating method: spray coating method using the compressed air, which is a method of imparting the irregularities by setting a spray nozzle more apart from the coating surface than usual to coat rather a little amount of the paint so as to generate coating unevenness. This method is more effective in the case of repeating coating and drying operations plural times. It is also effective to blow a wind to generate wind unevenness from the outside during the coating.

(3) Gravure coating method: method of imparting the irregularities by performing gravure coating by using plural printing cylinders having random and numerous dimples different in size and shape on a surface thereof.

(4) Screen printing method: method of imparting the irregularities by performing screen printing while putting numerous patterns different in size and shape on a screen.

(5) Air drying method: method of imparting thin wave-like irregularities by sending air, of which speed is varied, from one or plural air nozzles after the coating and before the drying and the curing.

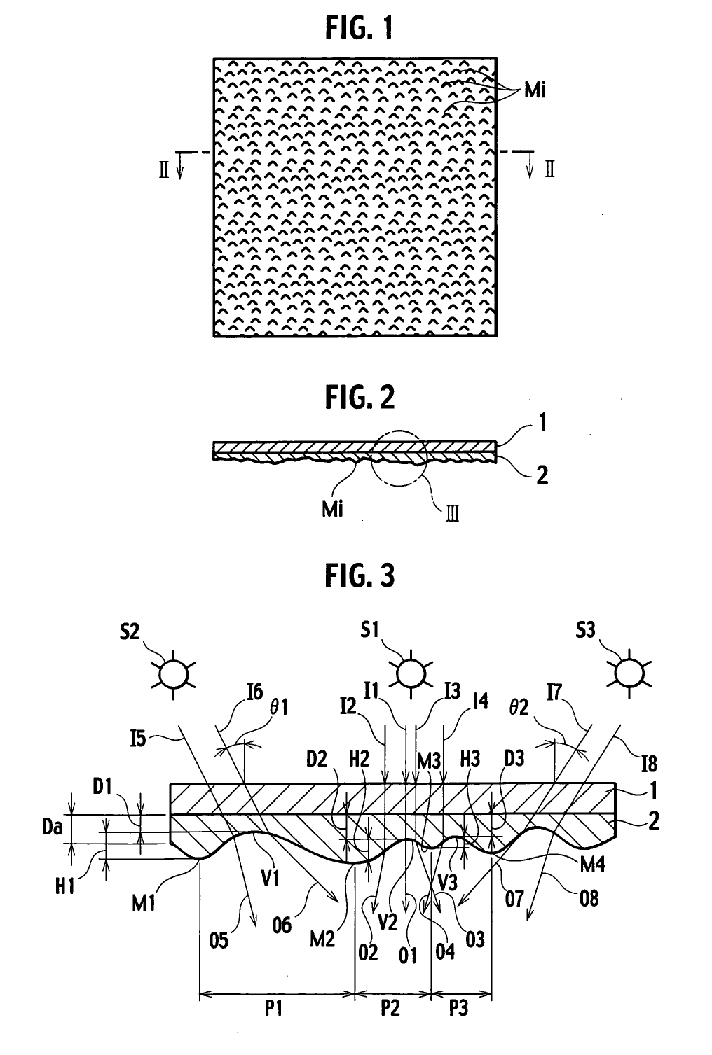

FIG. 1 is a plan view showing an embodiment of the light-scattering composite agricultural film of the present invention, which is obtained by the sponge roller coating method. FIG. 2 is a cross-sectional view taken by arrows II-II of FIG. 1. FIG. 3 is an enlarged view of a portion III of FIG. 2.

On one surface of the transparent base film A denoted by reference numeral 1, the transparent resin layer B containing the ultraviolet absorbent, which is denoted by reference numeral 2, is stacked. The surface of the resin layer B denoted by the reference numeral 2 has numerous convex portions Mi (i=1, 2, 3 . . . ) generated by the sponge roller coating, and irregularities including the convex portions form a random and irregular sine curve as shown in FIG. 3. Thicknesses Di (i=1, 2, 3 . . . ) of concave portions Vi (i=1, 2, 3 . . . ) of the irregularities, height differences Hi (i=1, 2, 3 . . . ) in the irregularities, and pitches Pi (i=1, 2, 3 . . . ) between the convex portions, are random individually. This is applied not only to the horizontal direction of FIG. 1 but also similarly to arbitrary directions, for example, the vertical direction and the diagonal directions.

A sunbeam from the midday sun S1 is made incident onto the base film A denoted by the reference numeral 1 substantially vertically. Incident light I1 passes through the concave portion V2, turns into transmission light O1, and travels straight. Incident lights I2 and I3 pass through both-side slant surfaces of the concave portion V2, are refracted in directions toward the convex portions M2 and M3, respectively, turn into transmission light O2 and O3, and then scatter. Moreover, incident light I4 passes through a slant surface, which is beyond the convex portion M3 and adjacent to the slant surface of the concave portion V3, transmits therethrough while being refracted in the direction toward the convex portion M3, turns into transmission light O4, intersects the transmission light O3, and then, also intersects the transmission light O1. When the above-described irregularities form the random and irregular sine curve, the scattering and crossing of the transmission light also become random, and all the transmission lights repeat the intersections with one another, and the intensities of the light beams are equalized. Specifically, such an effect as “smoothing hot water” for the light appears, and the light becomes gentle and soft beams and scatters evenly in the house, and then, the light falls on leaves of the plant. Accordingly, sunburn of the leaves as in the case of only the direct light is restricted, and the light also reaches evenly the shaded leaf portions and shadowy portions caused by a skeleton framework of the house, which are not directly exposed to the direct light. Then, the entire plant performs the photosynthesis uniformly, which favorably affects the growth of the plant. Light falling on one spot of the plant becomes not direct sunlight but scattered light. In addition, the light concerned becomes an aggregate of light scattered from the various regions through the outer surface of the house. This light changes continuously while time passes, and fluctuates on the surfaces of the leaves. In other words, the plant is settled in a state of lounging in a bathtub of the smoothed light.

Moreover, incident lights I5 to I8 from the sun S2 and the sun S3 in the morning and the evening are made incident obliquely at incident angles _{″}1 and _{″}2, respectively, different from those of the incident lights I1 to I4 from the midday sun S1. Accordingly, transmission lights O5 to O8 of the incident lights I5 to I8 individually scatter while being refracted more largely than the transmission lights O1 to O4, and fall on portions of the plant leaves, which are not exposed to the direct light from the midday sun S1 and the refracted scattered light thereof, and to the direct light from the sun S2 and the sun S3 in the morning and the evening. Accordingly, the incident lights I5 to I8 favorably affect the growth of the plant.

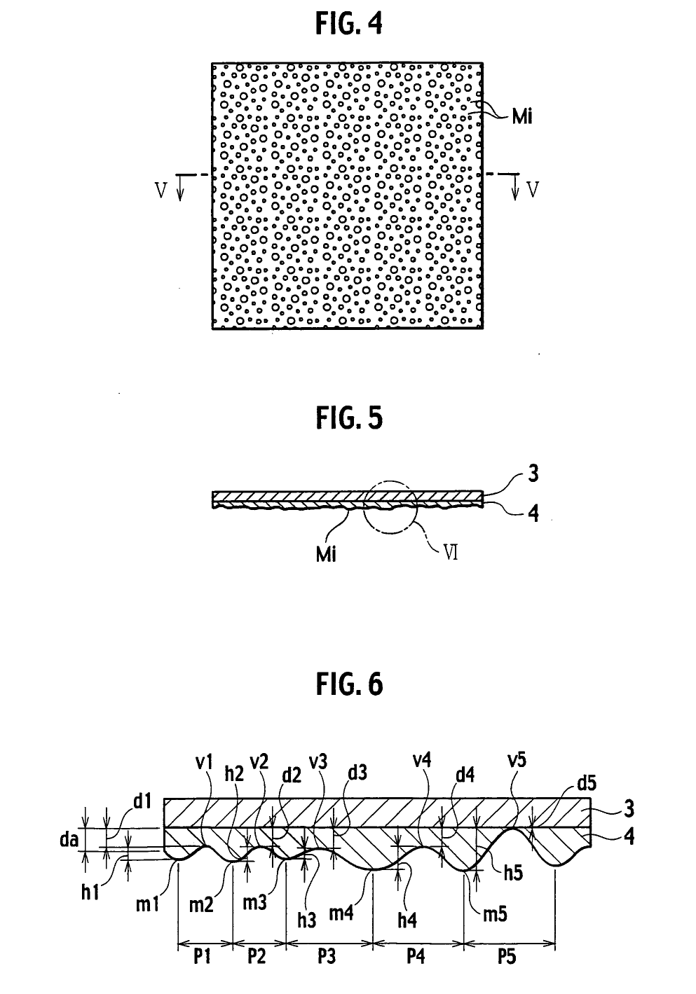

FIG. 4 is a plan view showing an embodiment of the light-scattering composite agricultural film of the present invention, which is obtained by the spray coating method. FIG. 5 is a cross-sectional view taken by arrows V-V of FIG. 4. FIG. 6 is an enlarged view of a portion VI of FIG. 5.

The surface of the resin layer B denoted by reference numeral 4 has numerous convex portions mi (i=1, 2, 3 . . . ) generated by the spray coating method. With regard to cross sections of irregularities including the convex portions, as in FIG. 3, an arbitrary vertical cross section of the resin layer B forms a random and irregular sine curve. Specifically, thicknesses di (i=1, 2, 3 . . . ) of concave portions vi (i=1, 2, 3 . . . ) of the irregularities, height differences hi (i=1, 2, 3 . . . ) in the irregularities, and pitches pi (i=1, 2, 3 . . . ) between the convex portions, are random individually. A different point of this embodiment from the case of the sponge roller coating in FIG. 3 is that a concave portion with a thickness of zero exists like a concave portion v5. Specifically, a portion in which the resin layer B is not coated on the base film A also exists, and it is not always necessary that the resin layer B be a continuous layer. As described above, in the spray coating, the case where such concave portions with the thicknesses of zero are sprinkled tends to increase the diffuse transmittance more at the same coating amount.

Average thicknesses Da and da of the resin layers B denoted respectively by the reference numerals 2 and 4 are 5 to 50 μm. Average values of the thicknesses Di and di of the concave portions are ⅓ to ⅔ of the average thickness Da in the case of the sponge roller coating, and ¼ to ⅔ of the average thickness da in the case of the spray coating. Moreover, average values of the height differences Hi and hi of the irregularities are ⅔ to 4/3 of the average thicknesses Da and da, respectively. Average pitches Pi and pi between the convex portions are 1 to 5 mm in the case of the sponge roller coating, 0.03 to 3.0 mm in the case of the spray coating, and 0.05 to 3.0 mm in the case of the gravure coating.

Next, the two typical coating methods are described by using the drawings.

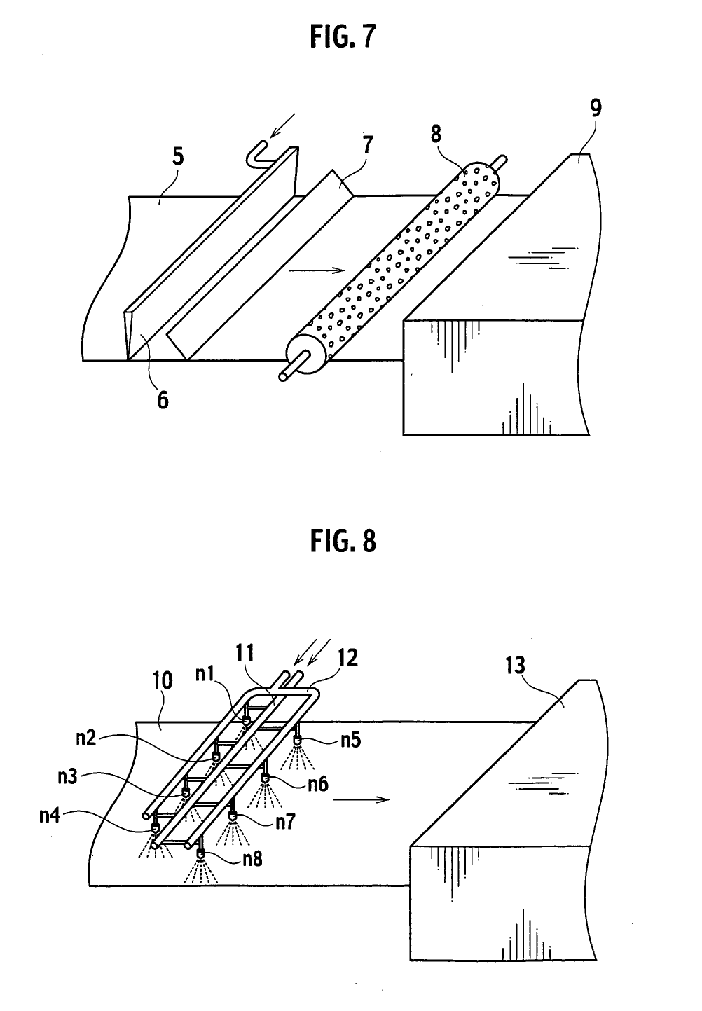

FIG. 7 is a perspective view showing an example of a sponge roller coater. The base film A denoted by reference numeral 5 is fed in a direction of an arrow (rightward in FIG. 7), a highly thixotropic aqueous paint (thixotropic coefficient: 3 to 6) is sent to a slit nozzle 6, discharged onto the base film 5, and is smoothed to a fixed thickness by a doctor blade 7. Thereafter, the numerous irregularities are imparted to the base film 5 by a sponge roller 8. Subsequently, the base film 5 is dried in a hot air dryer 9, and drying conditions differ depending on the average thickness of the resin layer B. In this case, the aqueous paint is coated more thickly than in the spray coating, and accordingly, it is necessary to sufficiently dry the base film 5 coated with the resin layer B. In general, drying conditions where a temperature is 40 to 100° C. and a period is 20 seconds to 5 minutes are suitable. After the drying, the base film 5 thus processed is cooled down, and wound into a roll by a winder (not shown).

FIG. 8 is a perspective view showing an example of a spray coater. The base film A denoted by reference numeral 10 is fed in a direction of an arrow (rightward in FIG. 8), and an aqueous paint usually with a low viscosity of 1 Pas or less is sent through a resin paint supply pipe 11 to spray nozzles ni (i=1 to 8). Meanwhile, pressured air is also sent through a pressured pipe 12 to the spray nozzles ni (i=l to 8) to spray the aqueous resin (aqueous paint) in mist form to the base film 10, thereby imparting the numerous irregularities to the base film 10 being fed. Subsequently, the base film 10 coated with the resin layer B is dried in a hot air dryer 13, and as drying conditions in this case, a temperature of 40 to 100° C. and a period of 20 seconds to 2 minutes are suitable. After the drying, the base film 10 thus processed is cooled, and wound into a roll by a winder (not shown). Although description is given of air spray coating in the example of FIG. 8, airless spray coating is also adoptable.

In the case of placing the light-scattering composite agricultural film of the present invention on the agricultural house, the resin layer B may be disposed either toward the outside or toward the inside of the agricultural house. In the case of disposing the resin layer B on the outside, there is an effect of protecting the base film A from the ultraviolet ray, and on the contrary, there is a defect that the resin layer B is deteriorated and polluted by being exposed by sunlight and the weather.

In order to restrict the defect, it is recommended to coat the above-described contamination resistant layer (contamination resist) on the outside of the resin layer B. Meanwhile, in the case of disposing the base film A on the outside, the base film A will be deteriorated and polluted by being damaged by the ultraviolet ray and the weather on the contrary. Accordingly, both of the above-described cases have merits and demerits. In the case of using the polyvinyl chloride as the base film A, the plasticizer is exposed to the outside and is prone to be polluted. Accordingly, it is recommended to provide the resin layer B by coating and drying the styrene-acrylonitrile-acrylic acid ester copolymer resin emulsion and the like on the outside of the base film A as described above. Moreover, in the case of coating the resin layer B on the base film of the existing agricultural house, it is recommended to coat the resin layer B on the outside of the house concerned in terms of the workability and the environment.

Examples are described below.

First, coating solutions for use are described.

[Preparation of Coating Solutions]

[Coating solution 1] To 100 parts by weight of GD90 (styrene-acrylic-acrylonitrile copolymer emulsion made by Nippon NSC Ltd.; concentration: 48%; Tg: 50° C.), there are added 10 parts by weight of TINUVIN 1130 (benzotriazole ultraviolet absorbent made by Ciba Specialty Chemicals Corp.), 6 parts by weight of butylcellosolve (film-forming assistant), 3 parts by weight of CS12 (film-forming assistant made by Chisso Corporation), 0.5 part by weight of Nopco 8034 (antifoaming agent made by San Nopco Limited), and 0.5 part by weight of EFKA 3580 (wettability improver). A solution thus obtained is agitated at 20° C. for 3 hours, followed by addition of water, and a coating solution 1 with a viscosity of 9.5 seconds (N-2 cup/25° C.) is thus prepared.

[Coating solution 2] To 100 parts by weight of Mowinyl 8030 (colloidal silica-containing acrylic emulsion made by Nichigo-Mowinyl Co., Ltd.; concentration: 44%; MFT: 30° C.), there are added 5 parts by weight of butylcellosolve, 3 parts by weight of Dalpad D (film-forming assistant made by The Dow Chemical Company), 4 parts by weight of Seesorb 102 (2-hydroxy-4-octoxybenzophenone: ultraviolet absorbent made by Shipro Kasei Kaisha, Ltd.), 6 parts by weight of TINUVIN 1130, 40 parts by weight of 40% water dispersing element of fine particles of antimony-doped tin oxide made by Sumitomo Osaka Cement Co., Ltd., 1 part by weight of SN deformer 398, 1.5 parts by weight of Pelex OTP (emulsifier made by Kao Corporation), and 1 part by weight of UH-420 (viscosity adjuster made by Asahi Denka Co., Ltd.). A solution thus obtained is agitated at 30° C. for 3 hours, followed by addition of water, and a coating solution 2 with a viscosity of 11.0 seconds (N-2 cup/25° C.) is thus prepared.

[Coating solution 3] To 100 parts by weight of Mowinyl 701 (acrylic emulsion made by Nichigo-Mowinyl Co., Ltd.; Tg: −20° C.; concentration: 44%) , there are added 30 parts by weight of ethanol, 1 part by weight of Pelex OTP, and 70 parts by weight of water. A solution thus obtained is mixed evenly, and a coating solution 3 for the primer is thus prepared.

[Coating solution 4] 100 parts by weight of Ecokimera CW-50 (contamination resistant titanium phosphate solution made by YOO Corporation), 1 part by weight of Yodozol KD11 (acrylic silicon emulsion made by Nippon NSC Ltd.), and 20 parts by weight of ethanol are evenly mixed together, and a coating solution 4 is prepared.

Next, Examples 1 to 10 are described. In Examples 1 to 10, examples of the films in themselves are shown.

[Preparation of Measured Films]

On a polyvinyl chloride film (JA Agricultural Vinyl Hi Hit 21 made by Chisso Corporation) with a thickness of 75 μm, the coating solution 1 is spray-coated while changing a coating amount thereof after drying so as to be values shown in Table 1 and is then dried by using the apparatus of FIG. 8, and films for Examples 1 to 6 are thus prepared. As Comparative example 1, a film that is not coated in the above-described way is prepared.

Next, SN-Thickener 640 (thickener made by San Nopco Limited) is added to the coating solution 1 to be thickened, and the thickened coating solution 1 is coated on a polyvinyl chloride film (fog/drop resistant film: Achilles Non-Killy Asuka made by Achilles Corporation) with a thickness of 100 μm so that coating amounts thereof after drying could be values shown in Table 1 and is then dried by using the line of the sponge roller coater of FIG. 7. In such a way, films of Examples 7 to 9 are thus prepared. As Comparative example 2, a film that is not coated in the above-described way is prepared.

Moreover, the coating solution 1 is coated on a polyvinyl chloride film (fog/drop resistant film: Achilles Non-Killy Asuka made by Achilles Corporation) with a thickness of 100 μm so that coating amounts thereof after drying can be values shown in Table 1 and is then dried by using a gravure coater. In such a way, a film for Example 10 and a film for Comparative example 3 is prepared.

Furthermore, as Comparative example 4, a polyvinyl chloride film (made by Chisso Corporation) with a thickness of 75 μm, which is commercially available and finished in satin finished surface, is also prepared.

[Measurements of Total Luminous Transmittance, Diffuse Transmittance, and Transmittance of Ultraviolet Ray with Wavelength of 370 nm]

For the films of Examples 1 to 10 and Comparative examples 1 to 4, which are prepared as described above, the total luminous transmittances and the diffuse transmittances are measured by using the double beam-type haze computer HGM-2B made by Suga Test Instruments Co., Ltd., and the transmittances of the ultraviolet ray with a wavelength of 370 nm are measured by using MCPD-2000 Spectrum made by Otsuka Electronics Co., Ltd. Results of the measurements are shown in Table 1.

As apparent from Table 1, it is found that the diffuse transmittances are higher and the haze values are also higher at the same coating amount in the case of the spray coating than in the case of the sponge roller coating. Moreover, in the case of the spray coating, it is found that, as the coating amount is being increased, the diffuse transmittance and the haze value are increased in up to Example 5 (coating amount: 25.8 g/m²); however, the diffuse transmittance and the haze value are reduced in Example 6 (coating amount: 35.5 g/m²) and after on the contrary. Moreover, it is found that, when the haze value exceeds 50%, the film becomes almost opaque, it is hardly possible to recognize a person apart by 2 m on an opposite side of the film, and the above-described value is an upper limit value of the haze value in the agricultural film. However, even if the film is opaque, no problem occurs on the cultivation and growth of the crops as long as the film satisfies the conditions where the total luminous transmittance is 85% or more, the diffuse transmittance is 6% or more, and the transmittance of the ultraviolet ray with a wavelength of 370 nm is 50% or less.

TABLE 1

| | | | | Total | | Parallel | Haze | Ultraviolet | |
|---|---|---|---|---|---|---|---|---|---|
| | | | Coating | luminous | Diffuse | light | value | (380 nm) | |
| | Base | | amount | transmit- | transmit- | transmit- | Td/Tt | transmit- | |
| No. | film | Coating method | (g/m²) | tance Tt (%) | tance Td (%) | tance Tp (%) | (%) | tance (%) | Remarks |
| Comparative | vinyl | uncoated | 0 | 92.33 | 2.19 | 90.14 | 2.37 | 87.4 | x transparent, poor |
| example 1 | chloride | | | | | | | | diffuse, many |
| | (75 μm) | | | | | | | | ultraviolet rays |
| Example 1 | vinyl | spray coating | 5.2 | 89.83 | 19.29 | 70.54 | 21.47 | 58.2 | ∘ semitransparent |
| | chloride | (actual line) | | | | | | | |
| | (75 μm) | | | | | | | | |
| Example 2 | vinyl | spray coating | 10.8 | 93.16 | 24.37 | 68.79 | 26.16 | 47.7 | ∘ semitransparent |
| | chloride | (actual line) | | | | | | | |
| | (75 μm) | | | | | | | | |
| Example 3 | vinyl | spray coating | 14.6 | 94.63 | 37.94 | 56.69 | 40.09 | 29.9 | ∘ semitransparent |
| | chloride | (actual line) | | | | | | | |
| | (75 μm) | | | | | | | | |
| Example 4 | vinyl | spray coating | 19.9 | 97.72 | 66.92 | 30.80 | 68.84 | 8.8 | Δ almost opague |
| | chloride | (actual line) | | | | | | | |
| | (75 μm) | | | | | | | | |
| Example 5 | vinyl | spray coating | 25.8 | 99.52 | 74.48 | 25.04 | 74.84 | 5.5 | Δ almost opaque |
| | chloride | (actual line) | | | | | | | |
| | (75 μm) | | | | | | | | |
| Example 6 | vinyl | spray coating | 35.5 | 97.93 | 67.58 | 30.35 | 69.01 | 5.3 | Δ almost opaque |
| | chloride | (actual line) | | | | | | | |
| | (75 μm) | | | | | | | | |
| Comparative | vinyl | uncoated | 0 | 92.41 | 3.19 | 89.22 | 3.45 | 63.1 | x transparent, poor |
| example 2 | chloride | | | | | | | | diffuse, many |
| | (100 μm) | | | | | | | | ultraviolet rays |
| Example 7 | vinyl | sponge roller | 22.2 | 91.53 | 6.83 | 84.70 | 7.46 | 5.7 | ∘ semitransparent |
| | chloride | (table test) | | | | | | | |
| | (100 μm) | | | | | | | | |
| Example 8 | vinyl | sponge roller | 38.8 | 88.90 | 10.22 | 78.68 | 11.50 | 3.0 | ∘ semitransparent |
| | chloride | (table test) | | | | | | | |
| | (100 μm) | | | | | | | | |
| Example 9 | vinyl | sponge roller | 48.7 | 94.83 | 41.76 | 53.07 | 44.03 | 1.5 | ∘ semitransparent |
| | chloride | (table test) | | | | | | | |
| | (100 μm) | | | | | | | | |
| Comparative | vinyl | gravure roller | 2.0 | 91.26 | 1.59 | 89.67 | 1.74 | 60.1 | x transparent |
| example 3 | chloride | (actual line) | | | | | | | |
| | (100 μm) | | | | | | | | |
| Embodiment | vinyl | gravure roller | 10.3 | 90.75 | 16.30 | 74.45 | 17.96 | 25.2 | ∘ semitransparent |
| 10 | chloride | (actual line) | | | | | | | |
| | (100 μm) | | | | | | | | |
| Comparative | vinyl | uncoated | 0 | 92.00 | 58.4 | 33.60 | 63.48 | 83.0 | Δ opaque |
| example 4 | chloride | | | | | | | | |
| | (satin) | | | | | | | | |

Note 1:
Tp = Tt − Td
Haze value = Td/Tt × 100%
Note 2:
Vinyl chloride (75 μm): JA Agricultural Vinyl Hi Hit 21, agricultural polyvinyl chloride made by Chisso Corporation (75 μm thickness)
Vinyl chloride (100 μm): Fog/drop resistant film Asuka Non-Killy, agricultural polyvinyl chloride made by Achilles Corporation (100 μm thickness)
Vinyl chloride (satin): Agricultural polyvinyl chloride made by Chisso Corporation (satin surface finish, 75 μm thickness)
Note 3:
Sponge roller: Mini roller (sponge roller) made by Industry Kowa Co., Ltd. (40 cmØ × 75 cm)
Note 4:
∘ . . . good, Δ . . . somewhat poor, x . . . poor
Note 5:
Brilliant shining/flickering phenomenon occurs in Examples 1, 2, 3, 8, 9, and 10, and does not occur in other examples.

Moreover, Examples 11 to 15 are described. In Examples 11 to 15, examples of using the film for the agricultural house are described.

[Preparation of Testing House]

Preparation of testing house for Example 11: On a polyvinyl chloride film (JA Agricultural Vinyl Hi Hit 21 made by Chisso Corporation) with a thickness of 75 μm, the coating solution 1 is spray-coated so that a coating amount thereof after drying could be 20 g/m² and is then dried by using the apparatus of FIG. 8, and a composite film on which the resin layer B having the irregular surface is formed is thus obtained. This composite film is placed on an agricultural house (3 m width×80 m length×2.5 m height) while disposing the resin layer B on the outside, and the preparation is thus performed.

Preparation of testing house for Example 12: A corona discharge treatment is performed for one surface of a polyester film with a thickness of 75 Am in a factory line. On the third day, on the treated surface, the coating solution 1 is coated so that a coating amount thereof after drying can be 20 g/m² and is then dried by using the gravure coater, and a composite film on which the resin layer B having the irregular surface is formed is thus obtained. This composite film is placed on an agricultural house with the same shape and size in the same procedure as those in Example 11, and the preparation is thus performed.

Preparation of testing house for Example 13: On a polyolefin film (Sky Court made by C.I. Kasei Co., Ltd.) with a thickness of 100 μm, the coating solution 3 is evenly coated so that a coating amount thereof after drying can be 10 g/m², and is then dried. Thereafter, the coating solution 1 is coated on the film concerned under the same conditions as those in Example 11, followed by drying. The film thus coated is placed on an agricultural house with the same shape and size in the same procedure as those in Example 11, and the preparation is thus performed.

Preparation of testing house for Example 14: On the resin layer B of the same composite film as that in Example 11, the coating solution 4 is spray-coated and dried, and the film thus coated is placed on an agricultural house with the same shape and size in the same procedure as those in Example 11, and the preparation is thus performed.

Preparation of testing house for Comparative example 5: A single-layer film on which the resin layer B is not formed, the single-layer film being a polyvinyl chloride film (JA Agricultural Vinyl Hi Hit 21 made by Chisso Corporation) with a thickness of 75 μm, is used to be placed on an agricultural house with the same shape and size in the same procedure as those in Example 11, and the preparation is thus performed.

Preparation of testing house for Comparative example 6: An uncoated polyvinyl chloride film (Agricultural Vinyl Cutace Kilinaine made by Mitsubishi Chemical MKV Company) with a thickness of 75 μm, which has the ultraviolet absorbent mixed therein, is used to be placed on an agricultural house with the same shape and size as those in Example 11, and the preparation is thus performed.

Preparation of testing house for Comparative example 7: On a polyvinyl chloride film (JA Agricultural Vinyl Hi Hit 21 made by Chisso Corporation) with a thickness of 75 μm, the coating solution 1 is spray-coated so that a coating amount thereof after drying could be 20 g/m²and have an even thickness, followed by drying. In such a way, a composite film having the resin layer B is prepared to be placed on an agricultural house with the same shape and size in the same procedure as those in Example 11, and the preparation is thus performed.

Preparation of testing house for Comparative example 8: A composite film is prepared under the same conditions as those in Example 11 except that a polyolefin film (Sky Court made by C.I. Kasei Co., Ltd.) with a thickness of 0.1 mm is used. The film concerned is placed on an agricultural house with the same shape and size in the same procedure as those in Example 11, and the preparation is thus performed.

Preparation of testing house for Example 15: On a polyvinyl chloride film (Achilles Non-Killy Asuka made by Achilles Corporation) with a thickness of 0.1 mm, the coating solution 2 is spray-coated so that a coating amount thereof after drying can be 20 g/m² and is then dried by using the spray coating line of FIG. 8, and the resin layer B having the irregular surface is formed. The film thus coated is placed on an agricultural house with an area of about 1650 m², in which ginger is cultivated, around the middle ten days of November while disposing the resin layer B on the outside, and the preparation is thus performed.

Preparation of testing house for Comparative example 9: Without coating the coating solution 2 on the same polyvinyl chloride film as that in Example 15 (Achilles Non-Killy Asuka made by Achilles Corporation), which has a thickness of 0.1 mm, the film concerned is placed on an agricultural house with an area of about 1650 m², in which ginger is cultivated, around the middle ten days of November as in Example 15, and the preparation is thus performed.

[Vegetable Growth Test in Testing Houses]

The testing houses for Examples 11 to 14 and Comparative examples 5 to 8, which were prepared as described above, were planted with saplings of tomato around the first ten days of May, and development situations thereof were observed. Results of the observation are shown in Table 2.

Moreover, the inside of testing houses for Example 15 and Comparative example 9, which were prepared as described above, were heated by heavy-oil stoves, and were always maintained at 20° C. or more for 8 days from around the middle ten days of December. Heavy oil consumptions during the period were measured, and the development situations of the ginger were also observed in the following March. Results of the observation are shown in Table 2.

As apparent from Table 2, in each of Examples 11 to 14 in each of which the coating solution 1 containing the ultraviolet absorbent was coated so as to form the irregularities, the ultraviolet transmittance was low, lowering of the total luminous transmittance with the elapse of days was small, an average daytime temperature in each house was lower than the outside of the house by 3° C. in average, shadows in the house were little, the surface of the tomato was red free from color unevenness, and an occurrence of the insect pests in the house was also little. Moreover, in Example 14, the contamination resist was coated, and accordingly, the lowering of the total luminous transmittance with the elapse of days was extremely small. An advantage of these Examples is extremely obvious in comparison with Comparative example 5 where the resin layer B was not provided. Moreover, in Comparative example 6 where the ultraviolet absorbent was mixed in the film and Example 7 where the coating solution 1 was evenly coated on the film, though the ultraviolet transmittances are little, there were many shadows in the house, and the color unevenness of the tomato was conspicuous.

Moreover, in Comparative example 8 where the coating solution 1 was coated on the polyolefin film so as to form the irregularities thereon, exfoliation of the resin layer B after two weeks was conspicuous, so there were many shadows in the house, and the color unevenness of the tomato was conspicuous. Furthermore, after the exfoliation of the resin layer B, the ultraviolet transmittance was high, and the occurrence of the insect pests was much.

Meanwhile, it is found that, in Example 15 where the coating solution 2 was coated on the base film so as to form the irregularities thereon, the consumption of the heavy oil for heating is less than in Comparative example 9 where the coating solution 2 was uncoated, and Example 15 has a heat insulating effect.

TABLE 2

| | | | Total | | | Average | | | | |
|---|---|---|---|---|---|---|---|---|---|---|
| | | Ultraviolet | luminous | | | temper- | | | | |
| | | (380 nm) | transmit- | | Adhesive- | ature | Heavy oil | | | Occurrence |
| | | transmit- | tance | | ness of | difference | consump- | Shadow | | situation |
| | | tance (%) | first day ′ | Coating | resin | from | tion for | State | | of whitefly |
| | | after two | after two | solution, | layer B to | outside | heating | inside of | Development | and |
| No. | Base film | months | months | coating method | base film | of house | for 8 days | house | of crops | Agromyzidae |
| Example | polyvinyl | ∘ 10.5% | ∘ 91% ′ 85% | coat solution 1 | ∘ good | ∘ −3° C. in | — | ∘ little | ∘ surface | ∘ little |
| 11 | chloride | | | to form | | daytime | | shadows | of tomato is | occurrence |
| | | | | irregularities | | | | | red free | |
| | | | | | | | | | from color | |
| | | | | | | | | | unevenness | |
| Example | polyester + | ∘ 9.8% | ∘ 93% ′ 90% | coat solution 1 | ∘ good | ∘ −3° C. in | — | ∘ little | ∘ surface | ∘ little |
| 12 | corona | | | to form | | daytime | | shadows | of tomato is | occurrence |
| | discharge | | | irregularities | | | | | red free | |
| | | | | | | | | | from color | |
| | | | | | | | | | unevenness | |
| Example | polyolefin + | ∘ 7.3% | ∘ 87% ′ 83% | coat solution 1 | ∘ good | ∘ −3° C. in | — | ∘ little | ∘ surface | ∘ little |
| 13 | primer | | | to form | | daytime | | shadows | of tomato is | occurrence |
| | layer | | | irregularities | | | | | red free | |
| | | | | | | | | | from color | |
| | | | | | | | | | unevenness | |
| Example | polyvinyl | ∘ 8.1% | ∘ 92% ′ 91% | coat solution 4 | ∘ good | ∘ −3° C. in | — | ∘ little | ∘ surface | ∘ little |
| 14 | chloride + | | | to the surface | | daytime | | shadows | of tomato is | occurrence |
| | contamina- | | | of Example 11 | | | | | red free | |
| | tion | | | | | | | | from color | |
| | resistant | | | | | | | | unevenness | |
| | layer | | | | | | | | | |
| Compar- | polyvinyl | x 88.4% | x 92% ′ 79% | Uncoated | — | x +3° C. in | — | x many | x green | x much |
| ative | chloride | | | | | daytime | | shadows | portion is | occurrence |
| example 5 | | | | | | | | | conspicuous | |
| | | | | | | | | | on surface | |
| | | | | | | | | | of tomato | |
| Compar- | UV cut type | ∘ 17.7% | x 90% ′ 77% | Uncoated | — | Δ −1° C. in | — | x many | x green | ∘ little |
| ative | polyvinyl | | | | | daytime | | shadows | portion is | occurrence |
| example 6 | chloride | | | | | | | | conspicuous | |
| | | | | | | | | | on surface | |
| | | | | | | | | | of tomato | |
| Compar- | polyvinyl | ∘ 5.0% | ∘ 92% ′ 89% | coat solution 1 | ∘ good | ∘ −2° C. in | — | x many | x green | ∘ little |
| ative | chloride | | | to form flat | | daytime | | shadows | portion is | occurrence |
| example 7 | | | | surface | | | | | conspicuous | |
| | | | | | | | | | on surface | |
| | | | | | | | | | of tomato | |
| Compar- | polyolefin | x 85.2% | ∘ 88% ′ 86% | coat solution 1 | x | +2° C. in | — | x many | x green | x much |
| ative | | | | to form | exfolia- | daytime | | shadows | portion is | occurrence |
| example 8 | | | | irregularities | tion is | after 1 | | after | conspicuous | |
| | | | | | conspicu- | month | | exfolia- | on surface | |
| | | | | | ous after 2 | | | tion of | of tomato | |
| | | | | | weeks | | | coating | | |
| | | | | | | | | film | | |
| Example | polyvinyl | ∘ 11.5% | ∘ 91% ′ 88% | coat solution 2 | ∘ good | ∘ +18° C. in | ∘ 1.48 kl | ∘ little | ∘ growth of | ∘ |
| 15 | chloride | | | to form | | nighttime | | shadows | corm is good | occurrence |
| | | | | irregularities | | | | | | is hardly |
| | | | | | | | | | | recognized |
| Compar- | polyvinyl | x 89.4% | ∘ 92% ′ 85% | uncoated | — | ∘ +16° C. in | x 1.74 kl | x many | Δ growth of | Δ slight |
| ative | chloride | | | | | nighttime | | shadows | corm is | occurrence |
| example 9 | | | | | | | | | somewhat | |
| | | | | | | | | | poor | |

Note 1:
∘ . . . good, Δ . . . somewhat poor, x . . . poor
Note 2:
Brilliant shining/flickering phenomenon occurs in Examples 11, 12, 13, 14, 15 and Comparative example 8, and does not occur in other examples.

The relationship between the occurrence, invasion, and breeding of the insect pests and the brilliant shining/flickering phenomenon is further described by showing an example.

Three sections of small vinyl houses each having an area of 54 m² was prepared, and the same film (the polyvinyl chloride film on which the coating solution 1 was spray-coated so as to form the irregularities thereon) as in Example 2 was placed on a section to be treated by an UV resistant solution of Example 16. The same film (the uncoated polyvinyl chloride film) as in Comparative example 1 was placed on a section to be untreated as in Comparative example 10. Moreover, the same film (the commercially available uncoated polyvinyl chloride film having the ultraviolet absorbent mixed therein) as in Comparative example 6 was placed on a section of the commercially available UV resistant film of Comparative example 11.

On May 9, 44 saplings of tomato were planted on each of the sections, and occurrence situations of whiteflies, Agromyzidae, thrips, and aphids were investigated. Results of the investigation are shown in Table 3.

TABLE 3

| | | | Comparative | Comparative |
|---|---|---|---|---|
| | | | example 11: | example 16: |
| | | Comparative | commercially | UV resistant |
| | | example 10: | available UV | solution |
| | | untreated film | resistant film | treatment |
| | | section | section | section |
| White- | Occurrence | frequently | less than | extremely |
| flies | situation | occurred in early | untreated | little |
| | | June and July | section | |
| | Ratio of | 33% | 27% | 0 to 7% |
| | host leaves | | | |
| | in late July | | | |
| Agro- | Occurrence | late June | not occurred | not occurred |
| myzidae | period | | | |
| | Ratio of | 23% | not occurred | not occurred |
| | damaged | | | |
| | leaves in | | | |
| | late July | | | |
| Thrips | Occurrence | late May | Early June | late June |
| | period | | | |
| | Ratio of | 80% | 10% | 3% |
| | damaged | | | |
| | leaves in | | | |
| | late July | | | |
| Aphids | Occurrence | middle May | middle May | late May |
| | period | | | |
| | Ratio of | 32% | 28% | 14% |
| | damaged | | | |
| | leaves in | | | |
| | middle June | | | |
| | Extinction | late July | Late July | late July |
| | period | | | |

As shown in Table 3, in the section (the section of the commercially available UV resistant film) of Comparative example 11, an occurrence rate of each insect pest is less than in the section (the section of the untreated film) of Comparative example 10, and an effect of the UV resistant treatment is observed. Further, in the section (the section onto which the UV resistant solution is spray-coated so as to form the irregularities thereon) of Example 16 of the present invention, the occurrence rate of each insect pest is much less than in the section of Comparative example 11. This is, in addition to the effect of the UV resistant treatment, an effect resulting from the increases of the diffuse transmittance and the brilliant shining/flickering phenomenon of the light, which are caused by randomly coating the UV resistant solution of the present invention so as to form the irregularities thereon.

Although the present invention has been described by illustrating the embodiment as described above, the present invention is not limited to the embodiment, and configurations of the respective portions can be replaced by arbitrary constituents having similar functions.

What is claimed is:

1. A light-scattering composite agricultural film, comprising:
a transparent base film; and
a transparent resin layer,
wherein at least either of the base film and the resin layer contains an ultraviolet absorbent, and has a transmittance of an ultraviolet ray with a wavelength of 380 nm of 60% or less, and
the resin layer includes, on a surface thereof, numerous irregularities, in which an total luminous transmittance is 85% or more, and a diffuse transmittance is 6% or more.

2. The light-scattering composite agricultural film according to claim 1,
wherein a haze value is 50% or less.

3. The light-scattering composite agricultural film according to claim 1,
wherein the numerous irregularities form a random and irregular sine curve on an arbitrary vertical cross section.

4. The light-scattering composite agricultural film according to claim 1,
wherein the base film is
a film made of any of polyvinyl chloride, polyvinylidene chloride, polyethylene, polypropylene, ethylene-vinyl acetate resin, ethylene-vinyl alcohol resin, polyester, polyamide, polyvinyl fluoride, polyvinyl alcohol, and biodegradable resin of polylactic acid, or
a composite laminate film of these, or
a film of these in which hydrophilicity is imparted to at least one surface thereof by a treatment including a corona discharge treatment, a plasma discharge treatment, an ultraviolet treatment, an ozone treatment, and a treatment using catalysts including titanium-oxide photocatalysts and a titanium-phosphate air catalyst.

5. The light-scattering composite agricultural film according to claim 1,
wherein the resin layer is made of at least one resin selected from acrylic ester polymers, styrene polymers, styrene-acrylic ester polymers, a vinyl acetate polymer, a copolymer formed of vinyl acetate and a monomer represented by the following formula, an ethylene-vinyl acetate copolymer, an ethylene-vinyl acetate-vinyl chloride copolymer, vinyl chloride polymers, a vinylidene chloride polymer, an acrylic-silicon copolymer, silica-containing acrylic resin, urethane resin, urethane-modulated acrylic resin, polyester resin, polybutadiene, polyethylene, an ethylene-methacrylic acid copolymer, epoxy resin, silicon resin, fluorine resin, biodegradable resin of polylactic acids, styrene-butadiene copolymer rubber, acrylonitrile-butadiene copolymer rubber, and methylmethacrylate-butadiene copolymer rubber: 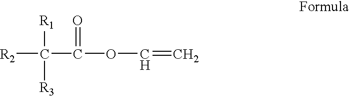
wherein R₁, R₂, and R₃ are alkyl groups.

6. The light-scattering composite agricultural film according to claim 1,
wherein the resin layer is formed by coating and drying a water-soluble or water-dispersive resin paint containing the ultraviolet absorbent.

7. The light-scattering composite agricultural film according to claim 3,
wherein the resin layer is formed by coating and drying a water-soluble or water-dispersive resin paint containing the ultraviolet absorbent.

8. The light-scattering composite agricultural film according to claim 5,
wherein the resin layer is formed by coating and drying a water-soluble or water-dispersive resin paint containing the ultraviolet absorbent.

9. The light-scattering composite agricultural film according to claim 1,
wherein, when the base film is an adherence-resistant film made of a material including polyolefin resin, polyester resin, and fluorine resin, a primer layer made of adhesiveness-improving resin is provided on a surface of the base film on the resin layer side.
